(19) United States
(12) Patent Application Publication
(10) Pub. No.: US 2025/0316259 A1
(43) Pub. Date: Oct. 9, 2025

(54) Dialog Generation Using Single-Speaker Documents

(71) Applicant: Google LLC, Mountain View, CA (US)

(72) Inventors: Yuzhe Zhao, San Francisco, CA (US); Arun Tejasvi Chaganty, Mountain View, CA (US); Kelvin Gu, Redwood City, CA (US); Zhuyun Dai, Sunnyvale, CA (US)

(21) Appl. No.: 18/866,446

(22) PCT Filed: May 17, 2022
(86) PCT No.: PCT/US2022/029569

§ 371 Date: Nov. 15, 2024

(51) Int. Cl. G10L 15/06; G06F 16/93; G06F 40/289; G06F 40/40

(52) U.S. Cl. CPC G10L 15/063; G06F 40/289; G06F 40/40; G06F 16/93

(57) ABSTRACT

Provided are systems, methods, and machine learning models for generating synthetic dialog training data using a single-speaker electronic document. The method includes receiving an electronic document and performing natural language processing on the electronic document to obtain a plurality of utterances. The method also includes, for each utterance of the plurality of utterances, generating, using a machine-learned inpainting model, an inferred prompt for which the utterance is an answer, storing each utterance and the associated inferred prompt as a data item for the dialog training set of data items.

### FIELD

The present disclosure relates generally to generating synthetic dialog training data using a single-speaker electronic document.

### BACKGROUND

Modern information-seeking tools, such as web searching and question answer, excel at questions that have well-defined answers, such as “When was the president born?”. However, many important questions are more open-ended, such as “How do I eat healthier?”. These open-ended questions usually require conversation to elicit context and explore in-depth. Conversational question answering systems (“ConvQA”) would empower users to answer these questions as if they could discuss with an expert at any time. However, progress in developing these systems has been hindered by the scarcity of conversational, or dialog, training data. Certain conversational data is abundant on the internet, such as conversations between users on forums and message boards. However, this conversation focuses primarily on personal anecdotes and subjective opinions and cannot be fact-checked, which is not desirable for an information-seeking system that desires responses that minimize personal biases and cite reliable sources. Directly crowd-sourcing dialogs and conversations is also a challenge: the largest extant data sets only contain about 10,000 conversations each and can still include actors in the conversation that are not subject-matter experts or who only provide shallow, uninformative answers. Therefore, there is a need for high-quality, expert-created information to be incorporated into dialog training sets.

### SUMMARY

Aspects and advantages of embodiments of the present disclosure will be set forth in part in the following description, or can be learned from the description, or can be learned through practice of the embodiments.

One example aspect of the present disclosure is directed to a method for generating a synthetic dialog training set of data items. The method includes receiving an electronic document and performing natural language processing on the electronic document to obtain a plurality of utterances. The method also includes, for each utterance of the plurality of utterances, generating, using a machine-learned inpainting model, an inferred prompt for which the utterance is an answer, storing each utterance and the associated inferred prompt as a data item for the synthetic dialog training set of data items.

Another example aspect of the present disclosure is directed to a non-transitory, computer-readable medium comprising instructions that, when executed by one or more processors, cause the one or more processors to perform a process. The process includes receiving an electronic document and performing natural language processing on the electronic document to obtain a plurality of utterances. The process also includes, for each utterance of the plurality of utterances, generating, using a machine-learned inpainting model, an inferred prompt for which the utterance is an answer, and storing each utterance and the associated inferred prompt as a data item for a synthetic dialog training set of data items.

A further example aspect of the present disclose is directed to a computer-implemented method for training a machine-learned inpainting model. The method includes receiving, by a computing system comprising one or more computing devices, a dialog training set of data items, each data item including an utterance from a dialog of two speakers, and generating, by the computing system, a partial dialog by masking an utterance of at least one data item. The method further includes predicting, by the computing system, the masked utterance based on the generated partial dialog, comparing, by the computing system, the predicted masked utterance to the masked utterance, and training, by the computing system, the machine-learned inpainting model based on the comparison.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that generates synthetic dialog data sets according to example embodiments of the present disclose.

FIG. 1B depicts a block diagram of an example computing device that generates synthetic dialog data sets according to example embodiments of the present disclose.

FIG. 1C depicts a block diagram of an example computing device that generates synthetic dialog data sets according to example embodiments of the present disclose.

FIG. 2 depicts a flow chart of a method for generating a synthetic dialog training set of data items according to example embodiments of the present disclosure.

FIG. 3 depicts a user interface including a sample dialog that can be generated from an inpainting model according to example embodiments of the present disclosure.

FIG. 4 depicts a flow chart of a method for training an inpainting model according to example embodiments of the present disclosure.

Reference numerals that are repeated across plural figures are intended to identify the same features in various implementations.

### DETAILED DESCRIPTION

### Overview

Generally, the present disclosure is directed to a dialog inpainter, which can take in electronic documents (such as articles, academic papers, and the like) and transform these “single-party” narrations into a synthetic “two-party” conversation, where the existing text of the document is used as answers to generated questions, such as the reply “In parental-supervised diets, students also usually ingest the proper proportion of foods from the different dietary groups; once removed from the parental dinner table, many college students do not eat enough fruits, vegetables, and dairy products” being a statement in the document and the generated question being “how does the freshman 15 relate to eating habits?” By transforming electronic documents into synthetic conversations, a variety of software applications can have a wider array of conversational training data, especially conversational training data that use expert analysis and facts (e.g., academic papers) as a basis for the synthetic conversation. To give an example, synthetic dialog training sets generated using methods described in this specification can be used to train e.g. ConvQA systems, for use in an automated assistant (e.g. voice assistant).

Systems (e.g. ConvQA systems) trained using synthetic dialog training sets generated in accordance with techniques described in this specification can provide improved continued human-machine interaction processes, for example between a human and an automated assistant. In some implementations, the trained ConvQA system may include or may receive input from a speech-to-text system which processes waveform data corresponding to voice inputs from a user to provide text output. The voice inputs may be captured by audio capture hardware (e.g. one or more microphones) and processed using the trained ConvQA system to generate a corresponding response, which in some implementations may be provided as audio generated by audio generation hardware (e.g. one or more speakers). In some examples, the audio capture hardware and the audio generation hardware may be included in a single device, e.g. an automated assistant device.

The present invention proposes the utilization of dialog inpainting to rewrite documents such as web documents, technical documents, (e.g., articles, studies, academic papers, and the like), and/or other forms of documents, into a “two-speaker dialog,” which can yield an enormous corpus of information-seeking dialogs with attributable, expert answers. To transform a document into a dialog, the original text of the document can be treated as a partial transcript of the conversation, where the sentences and phrases (“utterances”) in the document can be treated as “responses” to prompts said by a reader in an imaginary dialog. However, the reader's “prompts,” or questions that the responses are made in response to, are not present. Therefore, the prompts must be predicted, or inpainted as dialog to form an imaginary “two-speaker” conversation. An inpainter model can be trained to predict these missing prompts (e.g., unknown or unobserved questions). By interleaving the generated questions and the utterances from the document, a synthetic dialog is formed, with associated answers existing in the electronic document. This synthetic dialog can then be used as a training set for a variety of applications, including the ConvQA space.

The present invention can yield large data sets, as it enables vast amounts of “single-speaker” documents, such as articles, academic papers, journals, and the like, to be transformed into “two-speaker” dialogs. For example, when applied to open sources of information such as Wikipedia and web articles, two data sets totally over 19 million dialogs (1000 times larger than any existing data set used to train dialog software, such as conversational question-and-answer software) were generated while maintaining conversationality and answer adequacy metrics at least as good than previous crowd-sourced data sets. The generated dialogs include the good qualities of the professionally written input documents used to inpaint (e.g., topical diversity, coherent disclosure, evidence-backed claims, etc.) without needing to train on dialog data of the same quality.

As mentioned above, the inpainted data sets are especially powerful sources of training data for ConvQA systems. When used to train standard retriever and re-ranker architectures, the inpainted data sets advance state-of-the-art across three different ConvQA benchmarks (QRECC, OR-QUAC, TREC-CAST), delivering up to 40% relative gains on standard evaluation metrics. The inpainted data sets can also be used to train zero-shot retrieval performance without using any in-domain ConvQA data.

The present invention enables more efficient and higher quality training of software systems, especially those utilizing ConvQA systems. As mentioned above, there is a lack of conversational data sets that can be used to train machine-learned systems, including ConvQA systems. Furthermore, the available conversational data sets do not include expert research and analysis. The present invention allows for synthetic conversational data sets to be generated from any received electronic document, such as journalistic articles, academic papers, professional opinions, and other expert sources. These synthetic conversational data sets are more robust and include more expert-provided information than existing conversational data sets, and allows for customized data sets (e.g., medical journals being converted into medical conversational data sets for a ConvQA system for a health care provider) to be generated and then used as a training set for the specific ConvQA system. In turn, the trained ConvQA system's ability to perform “conversation” with users is improved because both the quality and quantity of training data is improved.

Furthermore, because the present invention creates such robust training data sets, the resulting trained systems, especially ConvQA systems, can obtain better information for conversations held with users more efficiently, thus reducing the total amount of interactions and processing needed to obtain accurate information the user is looking for. For example, the systems trained using synthetic data sets generated by the present invention can more quickly identify what type of information the user is looking for and can provide better information (e.g., from expert opinions and academic papers) to the user in a timelier manner than a system trained on existing conversational data sets. The ability to provide such information more quickly both improves the speed at which users can be assisted by the system and the quality of assistance the users receive.

### Example Devices and Systems

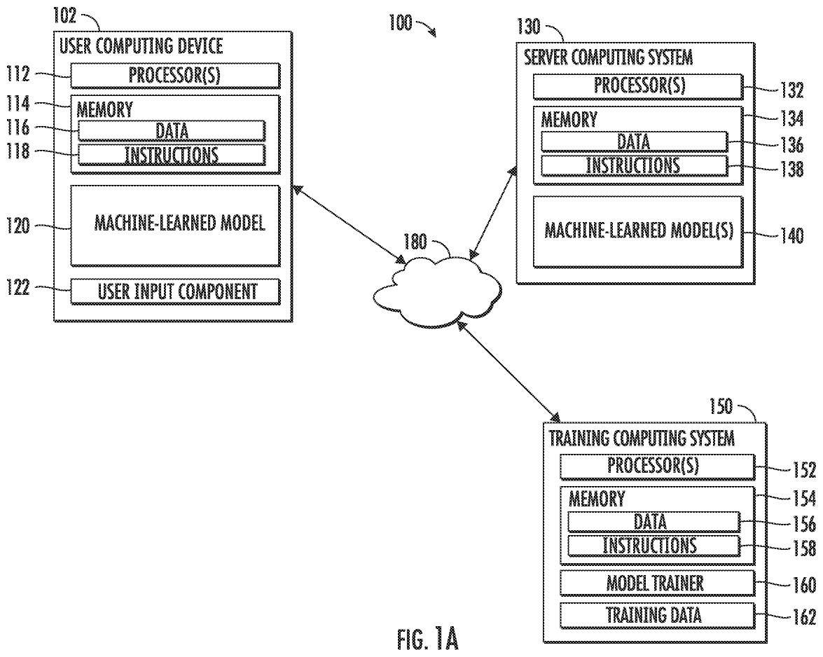

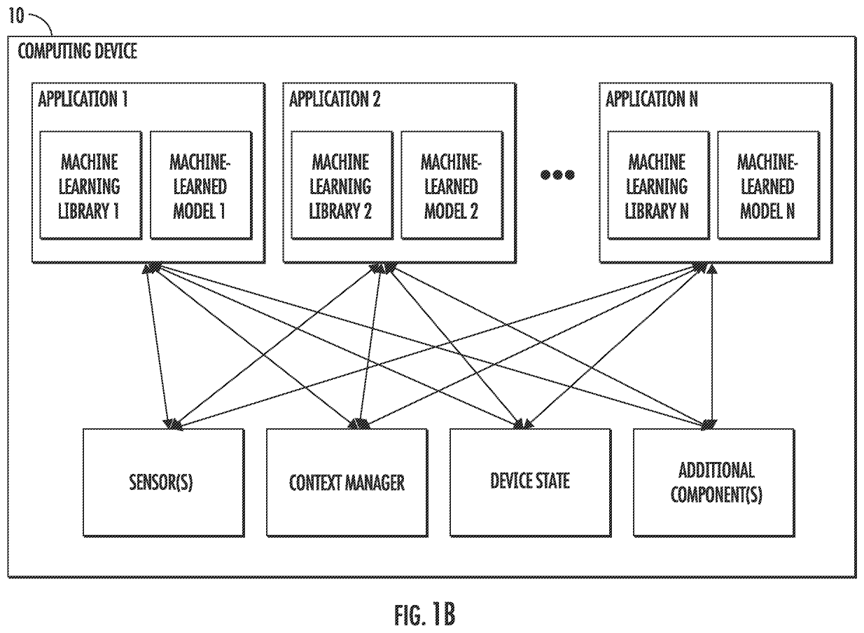

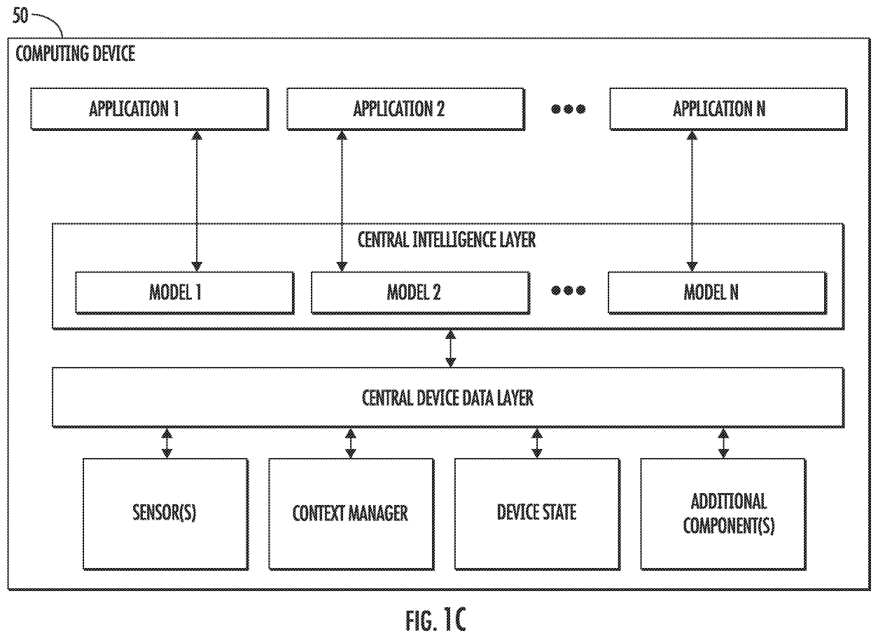

FIG. 1A depicts a block diagram of an example computing system 100 that generates synthetic dialog data sets from electronic documents according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned dialog inpainter models 120. For example, the machine-learned dialog inpainter models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned dialog inpainter models 120 can be received from the server computing system 130 over network 180, stored in the user computing device memory 114, and then used or otherwise implemented by the one or more processors 112. In some implementations, the user computing device 102 can implement multiple parallel instances of a single machine-learned dialog inpainter model 120 (e.g., to perform parallel dialog inpainting across multiple instances of dialog inpainting).

More particularly, the machine-learned dialog inpainter model 120 is used to perform dialog inpainting by generating a “two-person” conversation based on a received “single-speaker” electronic document. The machine-learned dialog inpainter model 120 receives an electronic document, such as an academic paper, article, and the like. Machine-learned dialog inpainter model 120 processes the electronic document, which is written from a singular perspective of the author and transforms the electronic document into a plurality of utterances (e.g., distinct sentences or phrases). The machine-learned dialog inpainter model 120 then generates synthetic prompts (e.g., questions) for each of the plurality of utterances, for example, based on each utterance and any utterances and/or generated prompts that occur prior to the specific utterance. In this way, the machine-learned dialog inpainter model 120 can use previous dialog context to better generate synthetic prompts for the particular utterance. For example, in response to receiving a statement from the electronic document that reads “In parental-supervised diets, students also usually ingest the proper proportion of foods from the different dietary groups; once removed from the parental dinner table, many college students do not eat enough fruits, vegetables, and dairy products,” the machine-learned dialog inpainter model 120 can generate an inferred prompt of “how does the freshman 15 relate to eating habits?” based on this utterance and any prior dialog context (prior utterances and generated prompts) in the “conversation.” In some embodiments, the inferred prompt can be determined using greedy decoding. Greedy decoding takes a calculated list of potential outputs and associated probability distribution and chooses the option with the highest probability. In other embodiments, other types of decoding can be used to select an inferred prompt. The machine-learned inpainter model 120 can output the inferred prompt and the associated utterance as a data item for a synthetic training set of data. This synthetic training set can be used to train a variety of machine-learned models used in conversational software applications, such as ConvQA applications.

The machine-learned dialog inpainter model 120 can be trained by using existing dialog training sets, such as open-source dialog training sets, that include an utterances from a dialog between two speakers. For each dialog, at least one utterance can be randomly masked, or replaced by a replacement character. The partial dialog is then used to predict the original value of the masked utterance. For example, the machine-learned dialog inpainter model 120 can be a generative model with parameters Θ specifying a probability distribution p_{Θ}(uₜ|dₘ₍ₜ₎), where dₘ₍ₜ₎ is the partial dialog and uₜ is the randomly sampled masked utterance from the dialog. The training objective is then to minimize the loss function shown in Equation 1:

$$ℒ ( θ ) = - {\sum }_{d ∈ 𝒟} \text{?} [ log {p}_{θ} ( \text{?} \vert \text{?} ) ] , \qquad Equation 1$$

$$\text{?} \text{indicates text missing or illegible when filed}$$

Equation 1 is a standard cross-entropy loss function. D is a corpus of complete dialogs. The loss function shown in Equation 1 is provided as an example. Other loss functions can be additionally or alternatively used.

The machine-learned dialog inpainter model 120 can receive an input as a text string, where the input is a dialog. A turn tis randomly sampled from the dialog, and the utterance u at turn tis masked. Next, each utterance in the dialog is prepended with a corresponding speaker identifier (e.g., 0 or 1 indicating which of the two people in the dialog said the particular utterance). The model then predicts the masked utterance and compares the prediction of the masked utterance to the original value of the masked utterance. The comparison is used in Equation 1 to minimize the loss function.

The machine-learned dialog inpainter model 120 can then be used to transform single-speaker documents, such as academic papers or articles, into a synthetic dialog. The single-speaker document is treated as a partial dialog, with masked utterances (the non-existent prompts or questions) being interleaved with utterances (sentences or phrases) from the single-speaker document. The machine-learned dialog inpainter model 120 can be provided an initial prompt (e.g., “Hello, I am an automated assistant and can answer questions about [document title]”), which indicates to the machine-learned dialog inpainter model 120 that the machine-learned dialog inpainter model 120 should be asking questions or otherwise providing prompts to the “given” answers in the received document. The machine-learned dialog inpainter model 120 can be trained on “organic” conversational data, where typically each speaker plays an implicit role in the conversation, such as “interviewer” and “interviewee” or other instances of “question poser” and “question answerer.” The input initial prompt enables the machine-learned dialog inpainter model 120 to infer that the first “speaker” from the document (e.g., the “speaker” associated with the first utterance from a document) will be in the question answerer role. From this, the machine-learned dialog inpainter model 120 can then infer that the “missing” second speaker plays the role of the question poser, causing the generated synthetic prompts to be questions. In a different example, the initial prompt can be “I disagree with everything you say!” In this case, the machine-learned dialog inpainter model 120 can infer that the two speakers are having a debate or argument, which would cause the missing second speaker to contradict the first speaker. Therefore, the machine-learned dialog inpainter model 120 can then generate opposing statements contradicting the utterances in the document instead of questions.

The received document is treated as a partial dialog containing multiple masked utterances. The machine-learned inpainter model 120 can be trained to inpaint only a single utterance at a time. To handle this, the machine-learned inpainter model 120 can be used autoregressively. The initial prompt, a first masked utterance (e.g., a synthetic prompt not currently existing in the document), and a first utterance from the document can be provided to the machine-learned inpainter model 120 as a first input. The first masked utterance is determined based on these inputs using greedy decoding. The next input into the machine-learned inpainter model 120 can therefore be the initial prompt, the first masked utterance replaced with the determined value, the first utterance from the document, a second masked utterance, and a second utterance from the document. These inputs are used to determine the second masked utterance. This process is repeated until all masked utterances (e.g., all prompts/questions to each utterance made in the document) are filled. The resulting output is a complete dialog.

In an example, dialog inpainting can be performed on two document corpora: Wiki, a collection of 11.4M passages from 5.9M English Wikipedia articles in the OR-QuAC retrieval corpus, and Web, a collection of 8.4M English web passages from the MS Marco retrieval corpus. Both corpora can be analyzed as is without any further filtering. The passages for each passage can be split into sentences using an NLP API. In certain embodiments, to limit computation, the first 6 sentences of each passage can be used instead of the entirety of the passage. The passages can then be converted to partial dialogs and inpainted using the methods described above.

The resulting data sets are information-seeking dialogs with well-matched questions and answers, making the data sets suitable for ConvQA software applications. The generated inferred prompts start with more definitional questions (e.g., what is, who is, where is, etc. style of questions) and then diversifies into a range of follow-up questions (what happened, did, is, how, why, etc. style of questions).

A ConvQA software application engages with a user through multi-turn dialog, where typically the user poses questions and the system answers. There can be exceptions, such as the ConvQA system asking a clarifying question. During a dialog, whenever it is the ConvQA system's turn to speak (at time t), the ConvQA system looks at all previous dialog turns d_{1:t}=(u₁, u₂, . . . , uₜ), called the dialog history, and outputs a new utterance, uₜ₊₁. Because ConvQA dialogs are knowledge-intensive, many systems decompose the task into a two-part retrieve-then-generate process. First, the ConvQA system employs a conversational retriever to retrieve passages that are relevant to the conversation based on the dialog history d_{1:t}. Second, the ConvQA system employs a generator which uses both the dialog history (d_{1:t}) and the retrieved passages to generate a response, uₜ₊₁. While both steps are important, the conversational retriever is key to helping the model access the right knowledge and also for showing people evidence for an answer.

The input to a conversational retriever is the dialog history (d_{1:t}) and a passage (p). The output is a score, s(d_{1:t},p), indicating the passage's relevance. Retrieval is performed by selecting the passages with the highest scores. The dialog history can also be referred to as the “query” and be denoted as q. In some benchmarks, the “dialog history” is defined to be all previous utterances, while in others the history is defined to only include the user's questions but not the system's responses. Two standard models can be used for retrieval. First, a dual encoder can be used to select an initial set of candidates. A cross-attention reranker can then rescore those candidates. In other embodiments, the machine-learned dialog inpainter model 120 can be used to train other types of conversational retrievers and/or other model architectures or configurations can be used.

As described above, each dialog generated by the machine-learned dialog inpainter model 120 tends to consist of alternating question and answer utterances: d=(sₚᵣₒₘₚₜ, û₁, s₁, . . . , ûₘ, sₘ), where inpainted utterances ûᵢ are questions, and their subsequent answers sᵢ are sentences from the original passage p. Intuitively, for each question in the dialog, p is a highly relevant passage that should be retrieved. Based on this observation, the following example can be generated. First, the machine-learned dialog inpainter model 120 can randomly select a dialog prefix that ends in a question to be the dialog history: qᵢ=(û₁,s₁, . . . ,ûᵢ). The original passage p is then marked as a positive passage to retrieve. However, directly using p as a positive example will not yield good results: the dialog history (qᵢ) includes exact sentences from p, which would cause the retriever to simply learn to string-match, rather than to generalize. To eliminate this problem, a new passage is formed that consists only of the remaining sentences in p that haven't appeared in qᵢ yet:

$${p}_{i}^{*} {=}^{def} Concat ( {s}_{j} where j > i ) .$$

After pre-training (qᵢ,p*ᵢ) pairs from the inpainted data, the retriever can be fine-tuned on a downstream ConvQA dataset.

Additionally or alternatively, one or more machine-learned dialog inpainter models 140 can be included in or otherwise stored and implemented by the server computing system 130 that communicates with the user computing device 102 according to a client-server relationship. For example, the machine-learned dialog inpainter models 140 can be implemented by the server computing system 140 as a portion of a web service (e.g., a dialog inpainting service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned dialog inpainter models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 1.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned dialog inpainter models 120 and/or 140 based on a set of training data 162. The training data 162 can include, for example, existing dialog datasets, such as PublicDialog, TaskMaster, OR-QuAC, and QReCC to train the machine-learned dialog inpainter model 120. Each dialog dataset can have different characteristics, such as being open-domain conversation datasets that do not contain any explicit question answering, relatively small conversational question answering dialog datasets, and other characteristics.

In some implementations, if the user has provided consent, training examples associated with the user can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, a ConvQA application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

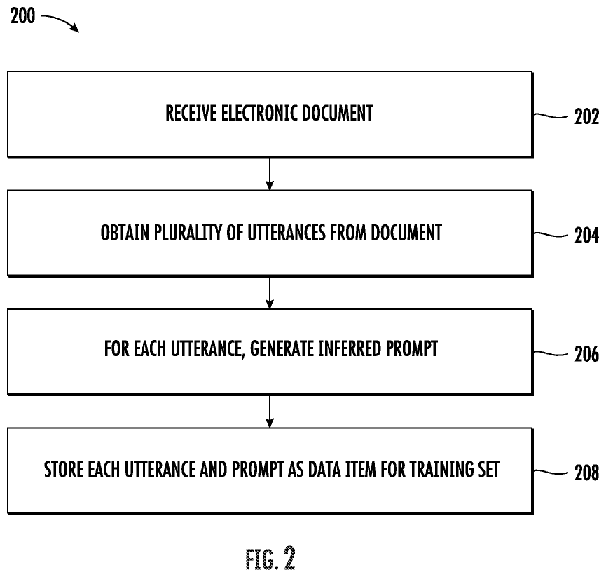

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

FIG. 2 depicts a flow chart of a method 200 for generating a synthetic dialog training set of data items according to example embodiments of the present disclose. In some embodiments, method 200 can be performed by one or more processors on one or more computing devices, such as one or more processors of user computing device 102, computing device 50, computing device 10, server computing system 130, or a combination of any of the computing devices.

At block 202, method 200 can include receiving an electronic document containing a plurality of sentences and phrases. As described above, the received electronic document can be a scientific or professional article, an academic paper, or other single-author (single-speaker) document. In some embodiments, the electronic document can be received as a file, such as a word processing file or a portable document format (“PDF”) file. In other embodiments, the electronic document can be received as a web page.

At block 204, method 200 can include obtaining a plurality of utterances from the received document. In some embodiments, obtaining the plurality of utterances includes performing natural language processing (“NLP”) on the received document to NLP is used to identify sentences and/or phrases in the received document. For example, NLP can be used to identify the ends of sentences or phrases (e.g., identifying semi-colons, periods, colons, or other punctuation and the like) and separate the sentences or phrases into distinct utterances. In other embodiments, other methods can be used to obtain the utterances from the document.

At block 206, method 200 can include, for each utterance of the plurality of utterances, generating an inferred prompt for the utterance using the machine-learned dialog inpainter model 120. As described above, the machine-learned dialog inpainter model 120 then generates synthetic prompts (e.g., questions) for each of the plurality of utterances. For example, in response to receiving an utterance from the electronic document that reads “In parental-supervised diets, students also usually ingest the proper proportion of foods from the different dietary groups; once removed from the parental dinner table, many college students do not eat enough fruits, vegetables, and dairy products,” the machine-learned dialog inpainter model 120 can generate an inferred prompt of “how does the freshman 15 relate to eating habits?” In some embodiments, the inferred prompt can be determined using greedy decoding. In some embodiments, the machine-learned dialog inpainter model 120 can use both the particular utterance and dialog context (e.g., prior utterances and prior generated synthetic prompts for other utterances) to generate the inferred prompt for the particular utterance.

The received document is treated as a partial dialog containing multiple masked utterances. The machine-learned inpainter model 120 can be trained to inpaint only a single utterance at a time. To handle this, the machine-learned inpainter model 120 can be used autoregressively. An initial prompt, or a first masked utterance (e.g., a synthetic prompt not currently existing in the document), and a first utterance from the document can be provided to the machine-learned inpainter model 120 as a first input. The first masked utterance is determined based on these inputs using greedy decoding. The next input into the machine-learned inpainter model 120 can therefore be the initial prompt, the first masked utterance replaced with the determined value, the first utterance from the document, a second masked utterance, and a second utterance from the document. These inputs are used to determine the second masked utterance. This process is repeated until all masked utterances (e.g., all prompts/questions associated with utterances made in the document) are filled.

At block 208, method 200 can include storing each utterance and associated inferred prompt as a data item in a synthetic dialog training set. The utterance and associated inferred prompt can then be used to train various software applications, such as ConvQA software applications, to perform a dialog with a user.

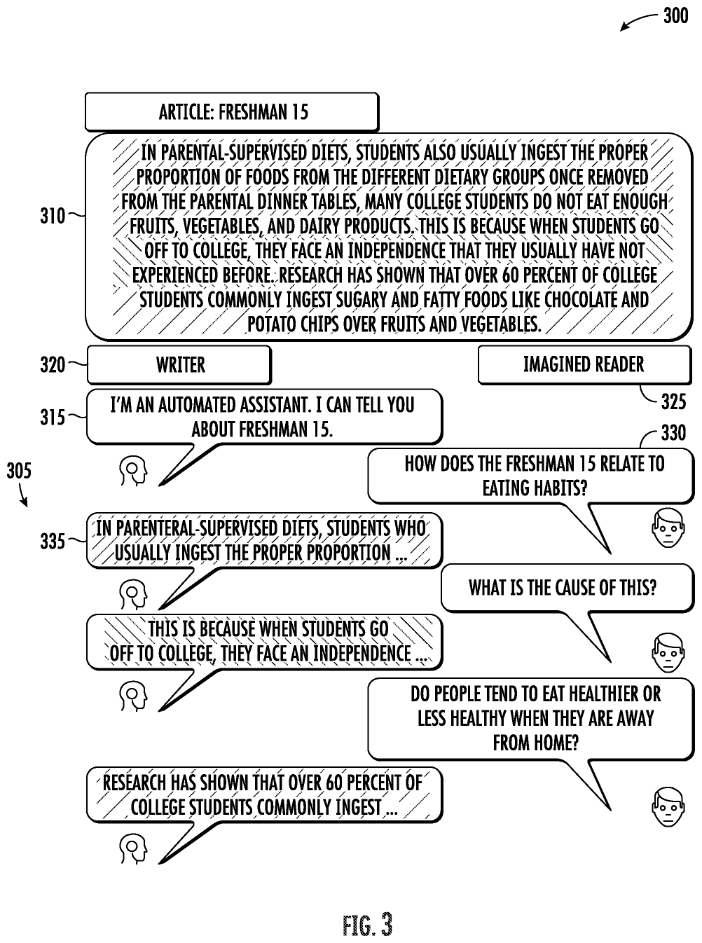

FIG. 3 depicts a user interface 300 including a sample dialog 305 that can be generated from an inpainting model according to example embodiments of the present disclosure.

Original document 310 is received and processed by the machine-learned dialog inpainter model 120. An initial prompt 315 is generated as a writer 320 of the original document, indicating to the machine-learned dialog inpainter model 120 to generate prompts to form a dialog. The machine-learned dialog inpainter model 120 can be provided an initial prompt (e.g., “Hello, I am an automated assistant and can answer questions about [document title]”), which indicates to the machine-learned dialog inpainter model 120 that the machine-learned dialog inpainter model 120 should be asking questions or otherwise providing prompts to the “given” answers in the received document.

The machine-learned dialog inpainter model 120 (represented by imagined reader 325) generates a prompt 330 in response to receiving the initial prompt from the writer 320. The writer 320 responds with utterance 335 representing a first sentence from the original document 310. This process then continues throughout the rest of the sample dialog 105.

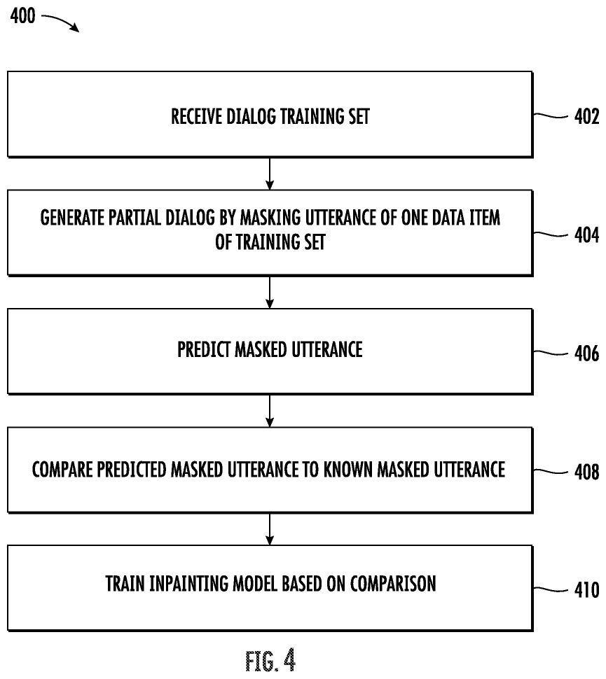

FIG. 4 depicts a flow chart of a method 400 for training an inpainting model according to example embodiments of the present disclosure. In some embodiments, method 400 can be performed by one or more processors on one or more computing devices, such as one or more processors of user computing device 102, computing device 50, computing device 10, server computing system 130, or a combination of any of the computing devices.

At block 402, the method 400 can include receiving a dialog training set. A dialog training set includes one or more data items (e.g., a plurality of utterances) made in a conversation between two or more speakers with associated identifiers (e.g., 0 and 1 for a conversation for two speakers, 0, 1 and 2 for a conversation with three speakers, and the like, or other identifiers) identifying which of the two speakers spoke the utterance. In some embodiments, the dialog training set can include normal conversation or can be focused on a particular form of conversation, such as a conversation including questions asked by one participant being answered by the second participant.

At block 404, the method 400 can include generating a partial dialog by masking at least one utterance from the plurality of utterances. In some embodiments, the utterance to mask is selected by sampling an utterance at random from the plurality of utterances. The partial dialog can be generated by replacing the original value of the masked utterance (e.g., a text string or similar value) with a replacement character, such as replacing the masked utterance with the symbol ⋄. The original value of the masked utterance can be stored as a target output value uₜ. The partial dialog and the target output value can then be input as an (x, y) pair to the machine-learned dialog inpainter model 120.

At block 406, the method 400 can include predicting the masked utterance using the machine-learned dialog inpainter model 120. The machine-learned dialog inpainter model 120 can receive the partial dialog generated at block 404 as an input and generate an output that predicts what the value of the masked utterance. in the partial dialog.

At block 408, the method 400 can include comparing the generated output predicting the value of the masked utterance. to the known value of the masked utterance uₜ. The output of the machine-learned dialog inpainter model 120 is compared to a “ground truth” value (the value of the masked utterance) to determine how accurate the prediction made by machine-learned dialog inpainter model 120 is compared to the actual value of the masked utterance. In some embodiments, a degree of similarity can be determined. For example, the value of the masked utterance can be “Tell me more about that topic” and the generated prediction by the machine-learned dialog inpainter model 120 can be “tell me more about that.” These two utterances can be determined to be similar to a degree, such as being 83% similar (for the predicted utterance having ⅚ of the words of the original utterance). In other embodiments, other methods of determining a similarity between the predicted utterance and the known value of the masked utterance can be used.

At block 410, the method 400 can include training the machine-learned dialog inpainter model 120 based on the comparison performed at block 408. Based on the similarity of the prediction generated by the machine-learned dialog inpainter model 120 to the actual value of the masked utterance, the machine-learned dialog inpainter model 120 can be trained to generate a prediction with a greater similarity to the actual utterance. For example, machine-learned dialog inpainter model 120 can be trained using backpropagation or another suitable training method to minimize the loss function as described with regards to Equation 1 above. Method 400 can then be repeated a number of times in order to minimize said loss function and train the machine-learned dialog inpainter model 120 using a variety of different masked utterances and partial dialogs to generate more accurate predicted utterances.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1.-20. (canceled)

21. A method for generating a synthetic dialog training set of data items, comprising:
receiving an electronic document;
performing natural language processing on the electronic document to obtain a plurality of utterances;
for each utterance of the plurality of utterances:
generating, using a machine-learned inpainting model, an inferred prompt for which the utterance is an answer; and
storing each utterance and the associated inferred prompt as a data item for the synthetic dialog training set of data items.

22. The method of claim 21, wherein each utterance of the plurality of utterances is a sentence or phrase.

23. The method of claim 21, further comprising:
providing an initial prompt to the machine-learned inpainting model, the initial prompt indicating that each inferred prompt should be a question with the associated utterance as the answer to the question.

24. The method of claim 21, wherein the inferred prompt is generated using greedy decoding.

25. The method of claim 21, wherein each utterance after a first utterance of the plurality of utterances is generated based on one or more prior utterances and associated inferred prompts for the utterances.

26. The method of claim 21, wherein the synthetic dialog training set is used to train a conversation question-and-answer model for a voice assistant.

27. A non-transitory, computer-readable medium comprising instructions that, when executed by one or more processors, cause the one or more processors to perform a process comprising:
receiving an electronic document;
performing natural language processing on the electronic document to obtain a plurality of utterances;
for each utterance of the plurality of utterances:
generating, using a machine-learned inpainting model, an inferred prompt for which the utterance is an answer; and
storing each utterance and the associated inferred prompt as a data item for a synthetic dialog training set of data items.

28. The non-transitory, computer-readable medium of claim 27, wherein each utterance of the plurality of utterances is a sentence or phrase.

29. The non-transitory, computer-readable medium of claim 27, the process further comprising:
providing an initial prompt to the machine-learned inpainting model, the initial prompt indicating that each inferred prompt should be a question with the associated utterance as the answer to the question.

30. The non-transitory, computer-readable medium of claim 27, wherein the inferred prompt is generated using greedy decoding.

31. The non-transitory, computer-readable medium claim 27, wherein each utterance after a first utterance of the plurality of utterances is generated based on one or more prior utterances and associated inferred prompts for the utterances.

32. The non-transitory, computer-readable medium of claim 27, wherein the synthetic dialog training set is used to train a conversation question-and-answer model for a voice assistant.

33. A computer-implemented method for training a machine-learned inpainting model, comprising:
receiving, by a computing system comprising one or more computing devices, a dialog training set of data items, each data item including an utterance from a dialog of two speakers;
generating, by the computing system, a partial dialog by masking an utterance of at least one data item;
predicting, by the computing system, the masked utterance based on the generated partial dialog;
comparing, by the computing system, the predicted masked utterance to the masked utterance; and
training, by the computing system, the machine-learned inpainting model based on the comparison.

34. The computer-implemented method of claim 33, wherein the masked utterance is selected at random from each utterance in the dialog training set of data items.

35. The computer-implemented method of claim 33, wherein generating the partial dialog further includes appending a speaker identification to each non-masked data item, the speaker identification identifying which of the two speakers has spoken the utterance associated with the data item.

36. The computer-implemented method of claim 35, wherein each data item in the partial dialog is concatenated into a text string.

37. The computer-implemented method of claim 36, wherein the masked utterance is represented in the text string as a symbol.

38. The computer-implemented method of claim 33, wherein training the inpainting model includes minimizing a loss function.

39. The computer-implemented method of claim 38, wherein the loss function is a cross-entropy loss function.

40. The computer-implemented method of claim 33, wherein the dialog training set is an open-source dialog training set.
